(19) United States
(12) Patent Application Publication
(10) Pub. No.: US 2025/0319402 A1
(43) Pub. Date: Oct. 16, 2025

(54) Resource Processing Method and Apparatus, Device, Medium and Program Product

(71) Applicant: Tencent Technology (Shenzhen) Company Limited, Shenzhen (CN)

(72) Inventor: Yao Li, Shenzhen (CN)

(21) Appl. No.: 19/247,088

(22) Filed: Jun. 24, 2025

Related U.S. Application Data
(63) Continuation of application No. PCT/CN2024/090736, filed on Apr. 30, 2024.

(30) Foreign Application Priority Data
Jun. 21, 2023 (CN) 2023107477129

(51) Int. Cl. A63F 13/57

(52) U.S. Cl. CPC A63F 13/57

(57) ABSTRACT

Aspects described herein provide resource processing techniques. The technique may include: obtaining spatial change information of a virtual character; obtaining static resource data of a hair resource of the virtual character in a second game scenario; obtaining dynamic resource data of the hair resource in the second game scenario based on the static resource data and the spatial change information; and performing physical simulation on the hair resource based on the dynamic resource data. In the aspects described herein, a world space coordinate system can be introduced into TressFx, to help the hair resource follow movement of the virtual character, to implement real movement performance.

### CROSS-REFERENCE TO RELATED APPLICATIONS

This application is a Continuation Application of PCT Application PCT/CN2024/090736, filed Apr. 30, 2024, which claims priority to Chinese Patent Application No. 202310747712.9, filed Jun. 21, 2023, each entitled “RESOURCE PROCESSING METHOD AND APPARATUS, DEVICE, MEDIUM, AND PROGRAM PRODUCT” and each of which is incorporated herein by reference in its entirety.

### FIELD

This application relates to the field of computer technologies, in particular, to the field of games, and specifically, to a resource processing technology.

### BACKGROUND

A TressFx (strand rendering) head hair framework is a hair rendering solution based on physical simulation. Open source TressFx may be integrated into various in-house developed rendering engines to implement hair rendering, so that the TressFx hair rendering solution is widely used.

Currently, although the TressFx uses a spring-mass system to simulate each hair, to achieve a realistic and perfect hair dynamic effect, the TressFx still has some disadvantages. For example, when simulating movement of a virtual character, the TressFx keeps a position of the virtual character unchanged, that is, the virtual character implements actions such as walking, running, and jumping at a same position. Consequently, in a movement process of the virtual character, a hair resource of the virtual character and the virtual character remain relatively fixed all the time, thereby failing to reflect a dynamic offset of the hair resource.

Therefore, when the TressFx is integrated into the in-house developed rendering engine, the TressFx is optimized, to facilitate improving a hair rendering effect of the in-house developed rendering engine.

### SUMMARY

Aspects described herein provide a resource processing method and apparatus, a device, a medium, and a program product, which can introduce a world space coordinate system into TressFx, to help a hair resource follow movement of a virtual character, to implement real movement performance.

According to one aspect, an aspect described herein provides a resource processing method, the method being performed by a computer device, and the method including:
obtaining spatial change information of a virtual character, the spatial change information indicating a position change of the virtual character in a world space coordinate system when the virtual character moves from a first game scenario to a second game scenario;
obtaining static resource data of a hair resource of the virtual character in the second game scenario, the static resource data being configured for reflecting a static characteristic of the hair resource when the virtual character is in a static state in the second game scenario;
obtaining dynamic resource data of the hair resource in the second game scenario based on the static resource data and the spatial change information, the dynamic resource data being configured for reflecting a dynamic characteristic that the hair resource moves with the virtual character; and
performing physical simulation on the hair resource based on the dynamic resource data, the physical simulation being configured for controlling the hair resource to simulate movement performance in a real world in a process in which the virtual character moves from the first game scenario to the second game scenario.

According to another aspect, an aspect described herein provides a resource processing apparatus, the apparatus being deployed on a computer device, and the apparatus including:
an obtaining unit, configured to obtain spatial change information of a virtual character, the spatial change information indicating a position change of the virtual character in a world space coordinate system when the virtual character moves from a first game scenario to a second game scenario,
the obtaining unit being further configured to obtain static resource data of a hair resource of the virtual character in the second game scenario, the static resource data being configured for reflecting a static characteristic of the hair resource when the virtual character is in a static state in the second game scenario; and
a processing unit, configured to obtain dynamic resource data of the hair resource in the second game scenario based on the static resource data and the spatial change information, the dynamic resource data being configured for reflecting a dynamic characteristic that the hair resource moves with the virtual character,
the processing unit being further configured to perform physical simulation on the hair resource based on the dynamic resource data, the physical simulation being configured for controlling the hair resource to simulate movement performance in a real world in a process in which the virtual character moves from the first game scenario to the second game scenario.

According to another aspect, an aspect described herein provides a computer device, the computer device including:
a processor, configured to load and execute a computer program; and
a computer-readable storage medium, the computer-readable storage medium having a computer program stored therein, and the computer program, when executed by the processor, implementing the foregoing resource processing method.

According to another aspect, an aspect described herein provides a computer-readable storage medium, the computer-readable storage medium having a computer program stored therein, and the computer program being applicable for being loaded and executed by a processor to implement the foregoing resource processing method.

According to another aspect, an aspect described herein provides a computer program product, the computer program product including a computer program, and the computer program, when executed by a processor, implementing the foregoing resource processing method.

In the aspects described herein, the spatial change information of the virtual character in the world space coordinate system may be obtained when the virtual character moves from the first game scenario to the second game scenario, and the spatial change information reflects a position change of the virtual character when moving in the world space. Then, acting the spatial change information on the static resource data of the hair resource of the virtual character in the second game scenario is supported, to obtain the dynamic resource data of the hair resource in the second game scenario, the static resource data being configured for reflecting a static characteristic of the hair resource when the virtual character in the second game scenario is in a static state, and the dynamic resource data being configured for reflecting a dynamic characteristic that the hair resource moves with the virtual character. Finally, physical simulation may be performed on the hair resource based on the dynamic resource data of the hair resource. The physical simulation enables the hair resource to simulate movement performance in the real world in the process in which the virtual character moves from the first game scenario to the second game scenario. In other words, the hair resource simulates the movement performance in the real world in the process in which the virtual character moves from the first game scenario to the second game scenario based on the physical simulation. It can be learned that, in the aspects described herein, world space simulation is added to the TressFx. The spatial change information of the virtual character moving from the first game scenario to the second game scenario acts on the static resource data of the hair resource, to obtain the dynamic resource data of the hair resource in the second game scenario, thereby more accurately controlling, based on the dynamic resource data, the hair resource to dynamically offset with the movement of the virtual character, so that the hair resource in the game world simulates and restores movement performance of the hair resource in the real world as much as possible, thereby improving naturalness and realism of the hair resource in the game scenario in which the virtual character moves.

### BRIEF DESCRIPTION OF THE DRAWINGS

To describe the technical solutions of the aspects described herein or the related art more clearly, the following briefly introduces the accompanying drawings required for describing the aspects or the related art. Apparently, the accompanying drawings in the following descriptions show only some aspects described herein, and a person of ordinary skill in the art may still derive other drawings from these accompanying drawings without creative efforts.

FIG. 1a is a schematic structural diagram of a hair resource according to an illustrative aspect described herein.

FIG. 1b is a schematic structural diagram of another hair resource according to an illustrative aspect described herein.

FIG. 1c is a schematic structural diagram of a wind field according to an illustrative aspect described herein.

FIG. 1d is a schematic diagram of a guide strand and a follow strand according to an illustrative aspect described herein.

FIG. 2 is a schematic diagram of comparison between a hair piece model and a strand model according to an illustrative aspect described herein.

FIG. 3 is a schematic flowchart of a resource processing method according to an illustrative aspect described herein.

FIG. 4 is a schematic diagram of a world space coordinate system according to an illustrative aspect described herein.

FIG. 5 is a schematic diagram of displacement and/or rotation of a virtual character according to an illustrative aspect described herein.

FIG. 6 is a schematic diagram showing that a strand is affected by gravity and wind according to an illustrative aspect described herein.

FIG. 7 is a schematic flowchart of another resource processing method according to an illustrative aspect described herein.

FIG. 8a is a schematic diagram of a virtual ponytail according to an illustrative aspect described herein.

FIG. 8b is a schematic diagram of a virtual braid according to an illustrative aspect described herein.

FIG. 8c is a schematic diagram of another virtual ponytail according to an illustrative aspect described herein.

FIG. 9 is a schematic structural diagram of a resource processing apparatus according to an illustrative aspect described herein.

FIG. 10 is a schematic structural diagram of a computer device according to an illustrative aspect described herein.

### DESCRIPTION OF ASPECTS

The following clearly and completely describes the technical solutions in aspects described herein with reference to the accompanying drawings in aspects described herein. The described aspects are only some of the aspects described herein rather than all of the aspects. All other aspects obtained by a person of ordinary skill in the art based on aspects described herein without creative efforts shall fall within the protection scope described herein.

Aspects described herein provide a resource processing solution. Specifically, the solution is a solution of physical simulation of a hair resource based on a TressFx framework. The following briefly describes technical terms and related concepts involved in the aspects described herein.

### 1. Physical Simulation of a Hair Resource

The physical simulation of the hair resource may be briefly referred to as hair physical simulation, is a computer graphics technology based on the principle of physics, and is configured for simulating a dynamic behavior of the hair resource (or a hair for short) or another elongated soft object. The hair may include, but is not limited to, head hairs (such as hair styles of various shapes (such as a ponytail, a bun, or a braid)), fringes (such as a side-swept fringe or a blunt fringe) of various shapes, temples, beard (such as a moustache or whiskers), fine hairs, and the like. Subsequent aspects described herein are described by using an example in which the hair resource is a head hair resource. This is specifically described herein.

The hair physical simulation mainly describes each hair resource by using a spring-mass system, and considers impact of an external factor such as gravity or wind on movement of the hair resource, to simulate a movement effect of the hair resource as much as possible when the hair resource is affected by the external factor in a real world. In the spring-mass system, one hair resource is considered to be formed by a plurality of vertexes (or referred to as particles) connected to a spring. Each vertex on one hair resource has a position vector and a velocity vector, and two adjacent vertexes are connected through the spring. When the vertex on the hair resource is subjected to an external force generated by the external factor, changes in a position and a velocity of the vertex can prompt movement and deformation of the hair resource as a whole, thereby simulating movement performance of the hair in the real world.

### 2. TressFx Framework

TressFx is a technology for implementing the hair physical simulation, and is specifically a head hair and hair rendering technology based on the physical simulation. The TressFx mainly implements a realistic dynamic movement effect of the hair based on a position-based dynamics (PBD) technology. The PBD is a physical simulation technology based on a constraint condition (or referred to as a constraint for short). A series of constraint conditions are imposed on each particle, to control movement of the particle to simulate a dynamic behavior of an object formed by the particle. Each particle in the PBD has a position vector and a velocity vector, and adjacent particles may be connected through the spring. The spring may be configured for representing an interaction caused after two connected particles are subjected to different types of forces. The force herein may include, but is not limited to, an external force such as gravity, air resistance, wind, or a pulling force.

In addition, the hair resource in the PBD may further be subject to various constraint conditions, the constraint conditions include, but are not limited to, a length limitation, an angle limitation, a global shape constraint, a gravity constraint, a local shape constraint, a movement following constraint, and the like. In this way, in a process of performing physical simulation on the hair resource, iterative calculation is performed based on various set constraint conditions, and a calculation result is applied to related particles forming the hair resource, to control movement of the related particles through the various constraint conditions, thereby ensuring movement authenticity of the hair resource. In addition, in addition to the foregoing various characteristics of the PBD, the TressFx further supports graphics processing unit (GPU) acceleration and multi-thread parallel processing. Compared with another hair rendering technology supporting central processing unit (CPU) processing and single-thread processing, hair rendering efficiency can be effectively improved.

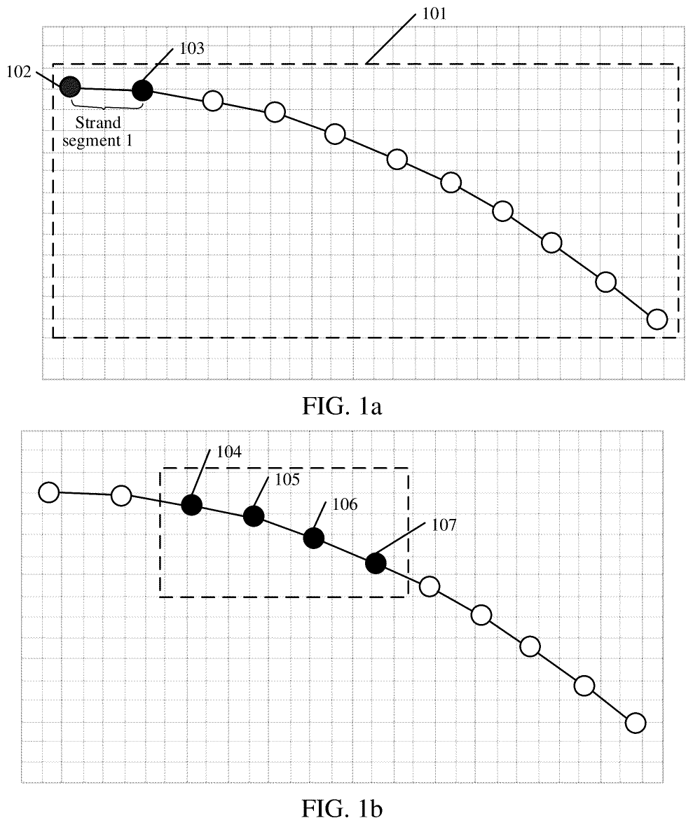

To better understand the TressFx, the following briefly describes a basic principle of the TressFx with reference to a hair resource shown in FIG. 1a. As shown in FIG. 1a, the TressFx equivalently attaches each hair resource (for example, one head hair) to a virtual hair (or referred to as a strand) on a virtual character (actor), and the virtual character (specifically, a head of the virtual character) is an attached object (hair-attached object) of the hair resource. The virtual hair is a continuous segment formed by a plurality of strand segments connected in a chain manner, each strand segment is formed by two endpoints connected through a virtual spring, and an endpoint of each strand segment is used as a vertex. For example, a strand 101 shown in FIG. 1a includes 10 continuous strand segments (which are respectively a strand segment 1→a strand segment 2→ . . . →a strand segment 10), the strand segment 1 is directly attached to the virtual character through a vertex 102, and the strand segment 2→ . . . →the strand segment 10 are sequentially connected to the strand segment 1. In an actual virtual scenario, if the hair resource moving with the virtual character needs to be simulated, movement of the vertex of the hair resource needs to be controlled to facilitate the hair resource to simulate movement performance of real hair in the real world.

009496.00160 7

To make the physical simulation for the hair resource be closer to a real phenomenon and improve realism and authenticity of the hair resource, the following constraints are further imposed on physical movement of the hair resource, to perform physical calculation on the hair resource. These constraints include, but are not limited to:
(a) Two vertexes (which may be referred to as root vertexes, for example, the vertex 102 and a vertex 103 shown in FIG. 1a) of the strand segment 1 of a root of the hair resource and the virtual character (that is, the hair-attached object) remain relatively fixed. The vertexes included in the strand segments connected to the root of the strand segment 1 present a free-fall effect due to a gravity (gravitational force) constraint and the spring connected between the vertexes. In other words, when the hair resource is the head hair on a head model of the virtual character, a root strand segment in the hair resource is directly connected to the head model of the virtual character, impact of a skeleton of the head model on movement directly acts on two root vertexes of the root strand segment, thereby further affecting subsequent vertexes of strand segments transferred to the hair resource, to achieve the movement effect of the entire hair resource.
(b) The hair resource needs to keep a specific curved shape (global shape constraints). Because the hair resource has specific stiffness (that is, a capability of a material or a structure to resist elasticity deformation when subjected to a force), the hair resource usually presents a specific flexible or curved shape. Therefore, in a process of simulating the movement of the hair resource, an original curved shape of the hair resource needs to be maintained, to implement more accurate hair simulation. In the TressFx, a plurality of vertexes located behind the root strand segment in the hair resource are mainly constrained through the global shape constraint, so that the hair resource formed by the vertexes keeps a basic curved shape, thereby simulating a styling effect of the head hair in the real world. As shown in FIG. 1b, the plurality of vertexes (such as a vertex 104, a vertex 105, a vertex 106, and a vertex 107) located behind the root strand segment 1 in the hair resource need to keep the specific curved shape, then the global shape constraint may be used to implement that a shape connected by the plurality of vertexes keep in the curved shape. Specifically, after the impact brought by the gravity constraint to the vertexes is calculated, a compensatory force is added to the vertexes to resist a gravity change, so that a specific pull-back is performed on a change of a vertex position because of the gravity constraint, thereby implementing that the vertexes are connected to form the specific curved shape.
(c) The hair resource needs to implement a corresponding velocity shock propagation (VSP) when following movement of the attached object, that is, a pulling acceleration affects a head hair position. The VSP, also referred to as velocity vibration propagation, is mainly that when a velocity of the attached object to which the hair resource is attached changes (that is, vibration is generated), vibration caused by the velocity is transmitted from the attached object to the hair resource, to cause the movement of the hair resource. When an acceleration of the attached object (for example, the attached object may be the head model of the virtual character) to which the hair resource is attached changes, a pulling acceleration is generated for the hair resource, so that the hair resource is subjected to a force. In this case, the hair resource may have a fluttering effect because of the force brought by the pulling acceleration. For example, a hair style of the virtual character is a long hair style, and when the virtual character suddenly accelerates forward under the control of a game player, the head hair of the virtual character is fluttered.
(d) A position of each vertex of the hair resource is affected by adjacent front and rear vertexes, that is, movement of adjacent vertexes follows a spring-mass model. Generally, a new position of the vertex of the hair resource after being affected by the front and rear vertexes is calculated through a local shape constraint (LSC).
(e) If there is a wind field in the virtual scenario in which the hair resource is located, the hair resource may further be affected by a wind influence in the wind field, thereby generating an effect of fluttering in the wind. Through wind field calculation, movement performance of the hair resource in a windy environment may be simulated. The TressFx mainly uses a square pyramid wind field, or referred to as a pyramid wind field shown in FIG. 1c, to implement the wind field calculation. Simply, the TressFx generates a false random number in a manner of solving a remainder of 20 (it is assumed that a quantity of vertexes on the hair resource is not a multiple of 20), then mixes the false random number with four side directions of the square pyramid, to obtain a fused wind direction within a range of the square pyramid wind field, and uses the fused wind direction as a wind direction for the wind field calculation of a current vertex.
(f) A length (length constraints) of each strand segment in the hair resource needs to remain unchanged, and a total length of the hair resource also needs to remain unchanged. Specifically, in an actual application, the length of the hair resource is fixed, but in a physical simulation process, the length of the hair resource changes, causing a problem that accuracy of the physical simulation is poor. The length constraint (where the length constraint is configured for controlling the length of the hair resource to remain unchanged in a movement process of the virtual character) is supported in the TressFx to relieve a problem of hair resource lengthening.
(g) A collision detection system in the TressFx is implemented based on a signed distance field (SDF). When the SDF performs collision detection on million-level hair volume, large overheads are needed, and performance consumption is large.

The foregoing (a) to (g) are illustrative constraints set by the TressFx for the physical movement of the hair resource. In addition, considering that a quantity of hair resources of the virtual character is large, to reduce a physical calculation amount of the hair resource, the TressFx further supports dividing the hair resource into a guide strand and a follow strand. In the physical simulation, dynamics simulation, wind field simulation, and the like need to be implemented for the guide strand. The guide strand generates a physical simulation result of the follow strand through offset, and collision detection and correction are performed on all strands. For an illustrative schematic diagram of generating the follow strand from the guide strand, refer to FIG. 1d. As shown in FIG. 1d, in an actual physical simulation process, the foregoing various types of physical simulation calculations are implemented for a guide strand 108, then a corresponding follow strand 109 may be generated by offsetting (for example, offsetting the position) the guide strand 108. In this way, a hair volume of the virtual character can be ensured while the calculation amount is reduced.

In an actual application, the TressFx provides a complete hair resource simulation solution, but some simulation solutions provided by the TressFx still worth optimizing and expanding. To better deal with a faster and more complex animation situation and improve the authenticity of the hair resource after open-source TressFx is integrated into an in-house developed rendering engine, in the aspects described herein, an encapsulated head hair simulation framework TressFx is extended, and some problems in the TressFx are optimized. The following briefly describes extensions and improvement points of the resource processing solution provided in the aspects described herein for the TressFx, and the extensions and the improvement points are described in detail in subsequent aspects.

### (1) Extension is Performed Based on the TressFx

Considering that displacement of the virtual character may affect the vertex of a hair resource, as described above, when the hair resource follows the movement of the attached object, the pulling acceleration may affect the head hair position. However, the physical simulation implemented by the TressFx needs to keep the virtual character from moving. For example, the virtual character performs actions such as walking, running, and jumping in place. In an actual scenario, the virtual character usually moves. For example, the virtual character runs from a first virtual scenario to a second virtual scenario, that is, the movement of the virtual character causes displacement in the world space. In this way, when the TressFx does not support the displacement in the world space, if the virtual character performs an action such as running, the hair resource of the virtual character and the virtual character always keep a relatively fixed posture, and a dynamic offset effect that the hair resource changes with the movement of the virtual character cannot be reflected.

Based on this, to better control the shape and the movement of the hair resource in the movement process of the virtual character, in the aspects described herein, world space simulation and a global offset function are added to the TressFx. The world space simulation and the global offset function can be used to effectively analyze an impact of the displacement of the virtual character on the vertex of the hair resource, and perform adaptability and personalized adjustment based on different movement situations of the virtual character, so that movement of the hair resource can achieve an optimal effect. Technical means of the world space simulation and the global offset function are added to the TressFx, so that a position, a direction, and an overall shape of the hair resource can be controlled more accurately, and more realistic movement performance can be implemented.

In the aspects described herein, in the movement process of the virtual character, spatial change information of the virtual character may be obtained. The spatial change information indicates a position change of the virtual character in a world space coordinate system when the virtual character moves from a first game scenario to a second game scenario. Then, the hair resource of the virtual character stores static resource data in each game scenario, and the static resource data may be configured for reflecting a static characteristic of the hair resource when the virtual character is in a static state in the second game scenario. In this case, dynamic resource data of the hair resource in the second game scenario may be generated based on the static resource data and the obtained spatial change information, and the dynamic resource data is configured for reflecting a dynamic characteristic that the hair resource moves with the virtual character. Finally, physical simulation is performed on the hair resource based on the dynamic resource data, so that in the process in which the virtual character moves from the first game scenario to the second game scenario, the hair resource simulates movement performance in the real world.

It can be learned that, in the aspects described herein, world space simulation is added to the TressFx. The spatial change information of the virtual character moving from the first game scenario to the second game scenario acts on the static resource data of the hair resource, to obtain the dynamic resource data of the hair resource in the second game scenario, thereby more accurately controlling, based on the dynamic resource data, the hair resource to dynamically offset with the movement of the virtual character, so that the hair resource in the game world simulates and restores movement performance of the hair resource in the real world as much as possible, thereby improving naturalness and realism of the hair resource in the game scenario in which the virtual character moves.

### (2) Optimization is Performed Based on the TressFx

1. A dynamic effect of the hair resource is optimized, including aspects such as fluttering, lateral movement, and fine hair dynamics. To achieve a more realistic hair simulation effect, in the TressFx, a physical engine is used to simulate a movement process of the hair, and an impact caused by factors such as the gravity, the air resistance, and the displacement of the virtual character on the movement of the hair resource is considered. Further, considering that a quantity of parameters corresponding to various factors provided by the TressFx is large, the aspects described herein support optimizing a calculation process through methods such as modifying the local shape constraint through parameter controlling and skinning data after animation, thereby enhancing the hair simulation effect of the virtual character in the movement process.

2. The plurality of hair resources can form the hair resource set, and the hair resource set may present a fixed shape (or a specific shape). For example, the fixed shape of the hair resource set includes any one of the following: the virtual ponytail, the virtual bun, and the virtual braid. For ease of description, an example in which the fixed shape of the hair resource set is the virtual ponytail (or the ponytail for short) is used. In the TressFx, if the virtual character performs quick squatting action (for example, from squatting to standing, or from standing to squatting) in place, the virtual ponytail easily has problems that a root of the ponytail is lifted, ends of the ponytail spreads out, the ponytail lacks a sense of drape, the ponytail is elongated, and the like in the movement process of the virtual character. Therefore, the aspects described herein provide various technical means to better control an overall shape of the virtual ponytail and the collision problem, and adjust the length constraint to optimize a lengthening effect.

For example, when resolving the problem that the virtual ponytail is easily lifted and lacks the sense of drape, parameters such as an elasticity coefficient and a gravity parameter are added to prevent the ponytail from being lifted and enhance the sense of drape of the ponytail. For another example, when resolving the problem that tail ends of the ponytail easily spreads out, a coefficient may be added to the local shape constraint to accurately identify tail ends of the ponytail, and an overall shape of tail ends of the ponytail is further fixed by adding the constraint, thereby preventing tail ends of the ponytail from spreading out and appearing unnatural in the movement process of the virtual character. For another example, when the TressFx deals with impact caused by a velocity change, there is actually only a position change amount that finally participates in calculation to change the vertex position in the hair resource. This calculation manner may cause hair resource lengthening. Even if the length constraint can relieve the problem of strand lengthening to some extent, stiffness and damping of the hair resource are small, and the acceleration is excessively large. When a sudden change in velocity is excessively large, there is still an apparent lengthening phenomenon. The aspects described herein supports adjusting a calculation sequence between the various constraint conditions to relieve the problem of strand lengthening, and also supports correcting the constraint formula of the length constraint, which is similar to adding a stiffness coefficient to relieve the problem of strand lengthening.

3. In the TressFx, vibration velocity propagation VSP is an important calculation process in the physical simulation. Currently, a calculation amount of the VSP is large. The aspects described herein supports modifying the calculation process of the VSP, and specializing a calculation manner of the VSP. Therefore, a better velocity vibration transmission effect can be obtained while improving calculation efficiency to implement a hair simulation process more quickly.

4. A hair resource generation policy is optimized: In a generation solution that is provided by the TressFx and that is of a parallel hair resource using 64 hair resources as a group, in the aspects described herein, a redundant hair resource included in the last generation group are no longer overlapped rendered and displayed, but display space of the redundant hair resource is changed to hide the redundant hair resource, thereby avoiding problems such as hair thickening caused by overlapping rendering, ensuring quality and reliability of the generated hair resource, and improving authenticity of hair rendering.

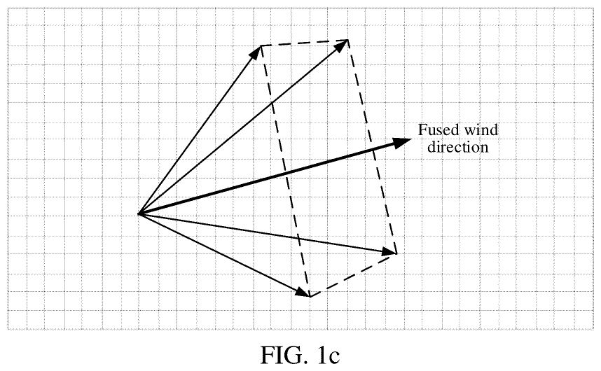

In the aspects described herein, the in-house developed rendering engine provided in the aspects described herein implements hair resource rendering based on the TressFx. Compared with a hair piece model, using a continuous curve to represent a virtual hair can better capture real and subtle movement and change of the hair resource, and present a more natural and realistic effect. In addition, using continuous curve modeling can accurately control overall modeling, thereby improving flexibility of modeling control. For a schematic diagram of comparison between an illustrative hair resource rendered by using the hair piece model and a hair resource rendered by using the TressFx, refer to FIG. 2. In addition, in the aspects described herein, a means such as world space simulation is added to the TressFx, so that an art designer can more accurately learn of a position, a direction, and an overall shape of the vertex in the hair resource, thereby implementing more realistic movement performance. Further, in the aspects described herein, some existing solutions in the TressFx are optimized. Compared with an original solution in the TressFx, a position and a direction of each vertex of the hair resource can be controlled and learned more accurately, thereby effectively grasping an entire shape of a hair resource plan of the hair resource. In conclusion, in the aspects described herein, through expansion and optimization of the foregoing technologies, performance and an effect of hair resource simulation are further improved based on the TressFx, a use range and an effect of the hair resource simulation solution in an actual application are expanded, and an effect requirement of a 3A game (that is, a game with high development costs, a long development period, and high resource consumption) is satisfied.

As described above, the resource processing solution provided in the aspects described herein is provided based on the TressFx framework. Therefore, the resource processing solution provided in this aspect described herein is universal and applicable to all application scenarios in which the TressFx framework is integrated and hair resource rendering needs to be performed. The application scenario may include, but is not limited to, a game scenario, a digital person scenario, a virtual reality (VR) scenario, an augmented reality (AR) scenario, and the like.

In a possible implementation, the application scenario may be the game scenario. There are a variety of game characters in the game scenario, and a game player may perform movements such as running, jumping, and flying by manipulating the game character. The resource processing solution provided in the aspects described herein is used to render the hair resource of the game character in a movement process, so that a dynamic effect of the hair resource can simulate, as much as possible, dynamic performance of the hair that needs to be presented when the game character performs movement in a real environment, and highly restore movement performance of the hair resource. For example, in a process in which a game character in the game scenario runs quickly, a hair resource of the game character dynamically changes with the game character. When the game character runs to the right, a root vertex of the hair resource of the game character is connected to a head model of the game character, but a tail vertex of the hair resource is always located at a left side of the root vertex. When the game character suddenly stops, the tail vertex of the hair resource is located at a right side of the root vertex due to inertia.

In a possible implementation, the application scenario may be the digital person scenario. A digital person or a virtual person is a digital character image that is close to a human image and that is created by using the digital technologies. The digital person may be applied to various fields, including but not limited to, applied to an audio/video call. In this case, a real person during the audio/video call may be converted into the digital person, and the digital person simulates a hair style, an expression, an action, and the like of the real person, or applied to a guided human-computer interaction scenario. In this scenario, the digital person may explain (for example, intelligently explain in a museum) content to a user, prompt an action (for example, prompt the user to perform some operations in an interface), or the like. An application field of the digital person is not limited in the aspects described herein. When the digital person may be applied to any application field, physical simulation may be performed on a hair resource of the digital person by using the resource processing solution provided in the aspects described herein, to pursue a more realistic and detailed hair rendering effect, thereby providing immersive experience for the user.

In a possible implementation, the application scenario may be the VR scenario or the AR scenario. VR and AR are two simulation technologies that can bring the user into a virtual world. A difference between the AR and the VR is that, the AR adds digital information to the real world, so that the user experiences abundant and interactive digital information in an original environment, while the VR completely isolates the real world, and places the user into a virtual environment. In the VR scenario or the AR scenario, the virtual character may need to be rendered in the virtual world. For example, the virtual character may be a person or an animal carrying the hair resource. In this case, the resource processing solution provided in the aspects described herein may be used to render the hair resource of the virtual character, to improve realism of the virtual character in the VR scenario or the AR scenario and improve immersive experience of the user.

The foregoing descriptions are merely illustrative descriptions of an application scenario to which the aspects described herein are applicable, and do not limit the application scenario to which the aspects described herein are applicable.

The aspects described herein support execution of the resource processing solution by a computer device. The computer device may be any device on which the in-house developed rendering engine is deployed. The in-house developed rendering engine integrates the TressFx framework, and uses this solution to expand and optimize the framework. The computer device may be a terminal device, and the terminal device may include, but is not limited to, devices such as a smartphone, a tablet computer, a portable personal computer, a mobile Internet device (MID for short), an in-vehicle device, and a head-mounted device. Types of the terminal device are not limited in the aspects described herein, and are described herein. In some aspects, the computer device may be a server. The server may be an independent physical server, or may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network, and big data and an artificial intelligence platform. A specific type of the server is not limited in the aspects described herein.

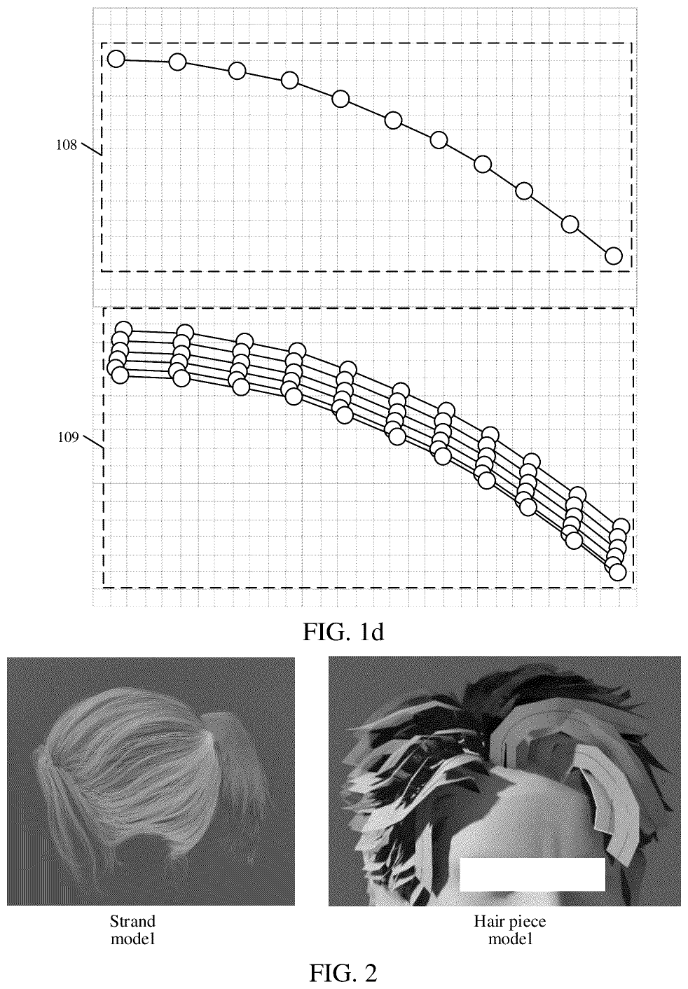

Based on the foregoing described resource processing solution, the aspects described herein provide a more detailed resource processing method. It can be known from the foregoing descriptions that in the resource processing solution provided in the aspects described herein, the TressFx is mainly extended and optimized. An extended part (that is, the world space simulation and the global offset function are added to the TressFx) for the TressFx is described in detail below with reference to FIG. 3. FIG. 3 is a schematic flowchart of a resource processing method according to an illustrative aspect described herein. The resource processing method may be performed by the computer device described above, and the resource processing method may include, but is not limited to, operations shown in operation S301 to operation S304.

Operation S301: Obtain spatial change information of a virtual character.

The spatial change information of the virtual character may indicate a position change of the virtual character in a world space coordinate system when the virtual character moves from a first game scenario to a second game scenario. In other words, the spatial change information represents a change situation of a position of the virtual character when the virtual character moves in the world space coordinate system. A game scenario in this aspect described herein may correspond to an image frame, that is, one game scenario corresponds to one image frame. The image frame may be configured for describing the game scenario from an image dimension. Therefore, when a plurality of consecutive image frames are played in sequence, a dynamic process in which the virtual character moves from one game scenario to another game scenario can be presented.

This aspect described herein supports obtaining the spatial change information of the virtual character through different image frames including a movement process of the virtual character. In a possible implementation, a first image frame corresponding to the first game scenario when the virtual character is in the first game scenario may be obtained, and first spatial position information of the virtual character in the first image frame in the world space coordinate system is calculated, the first spatial position information indicating a spatial position of the virtual character in the first game scenario. Similarly, a second image frame corresponding to the second game scenario when the virtual character is in the second game scenario may be obtained, and second spatial position information of the virtual character in the second image frame in the world space coordinate system is calculated, the second spatial position information indicating a spatial position of the virtual character in the second game scenario. In a 3D (Dimensions) game (that is, a game in which an operation is implemented by using spatial three-dimensional calculation technologies), the spatial position information (for example, the first spatial position information and the second spatial position information) described above may be represented as (x, y, z). x represents a position of the virtual character on a horizontal axis x of the world space coordinate system, y represents a position of the virtual character on a vertical axis y of the world space coordinate system, and z represents a position of the virtual character on a depth axis z of the world space coordinate system. When x=0, y=0, and z=0, a point (0, 0, 0) is an origin of the world space coordinate system. Finally, the spatial change information of the virtual character may be calculated based on the first spatial position information of the virtual character in the first game scenario and the second spatial position information of the virtual character in the second game scenario.

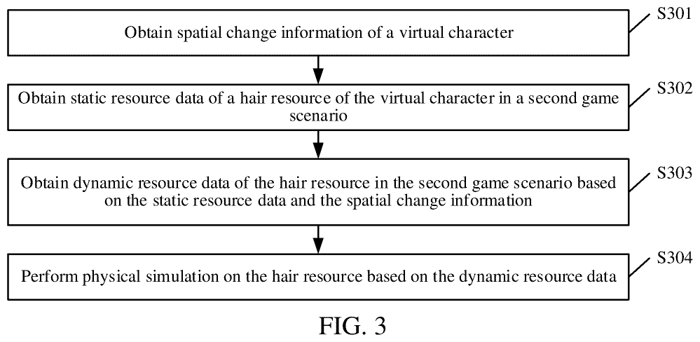

For an illustrative schematic diagram of an illustrative world space coordinate system, refer to FIG. 4. As shown in FIG. 4, for ease of description, a dot 401 is used to represent the virtual character. It is assumed that the first spatial position information of the virtual character in the first game scenario is represented as (x1, y1, z1). When the virtual character moves from the first game scenario to the second game scenario, it is assumed that the second spatial position information of the virtual character in the second game scenario is represented as (x2, y2, z2). Values on same axes in the first spatial position information (x1, y1, z1) and the second spatial position information (x2, y2, z2) are subtracted (for example, a position x1 on the horizontal axis-a position x2 on the horizontal axis, position y1 on the vertical axis-position y2 on the vertical axis, and a position z1 on the depth axis-a position z2 on the depth axis). A value obtained by subtraction is a movement distance of the virtual character on the axis, and a sign (for example, a positive sign “+” or a negative sign “−”) obtained by subtraction indicates a movement direction of the virtual character along the axis.

Operation S302: Obtain static resource data of a hair resource of the virtual character in the second game scenario.

Operation S303: Obtain dynamic resource data of the hair resource in the second game scenario based on the static resource data and the spatial change information.

In operation S302 and operation S303: 1. The hair resource of the virtual character has the static resource data (specifically, static resource data of a root vertex of each hair resource) in each image frame (that is, the game scenario), and the static resource data may be configured for reflecting a static characteristic of the hair resource when the virtual character is in a static state in the corresponding game scenario. The static resource data may specifically include static position information and static direction information of the hair resource, and the static characteristic is represented through the static position information and the static direction information. The static position information indicates a position of the hair resource when the virtual character keeps static in the game scenario, and the static direction information indicates a direction (the direction of the hair resource may be simply understood as a rotation angle of an attached object to which the hair resource is attached, for example, if the attached object is a head model of the virtual character, the rotation angle may be a rotation angle of the head model) of the hair resource when the virtual character keeps static in the game scenario.

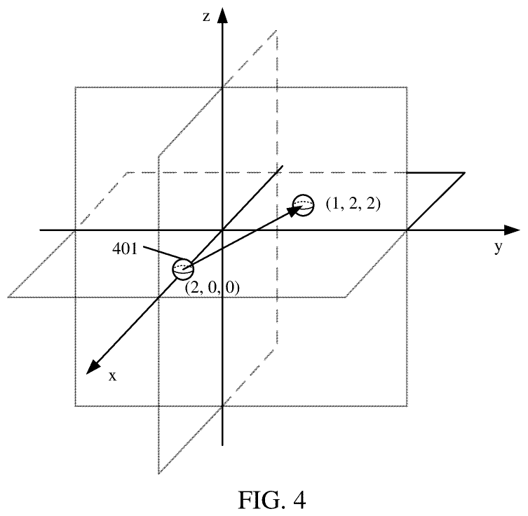

2. The spatial change information of the virtual character between two image frames (for example, the first image frame and the second image frame described above) when the virtual character moves may be represented in a matrix form, and spatial change information in the matrix form includes displacement information and rotation information of the virtual character between the two image frames. The displacement information in the spatial change information indicates information such as a displacement distance and a displacement direction generated when the virtual character moves from the first game scenario to the second game scenario. For example, the displacement information indicates that the virtual character moves by 10 meters (the displacement distance) along a positive direction (the displacement direction) of the x axis of the world space coordinate system when the virtual character moves from the first game scenario to the second game scenario. The rotation information in the spatial change information indicates a rotation angle of the head model of the virtual character in the world space coordinate system when the virtual character moves from the first game scenario to the second game scenario. In a visual effect, the head model of the virtual character rotates, such as the rotation caused by tilting the head to look to the left or raising the head to look up. For an illustrative schematic diagram that the virtual character displaces and rotates at the same time when the virtual character moves from the first game scenario to the second game scenario, refer to FIG. 5. As shown in a first figure shown in FIG. 5, when the virtual character changes from facing forward to raising the head to the upper left corner, it is determined that the head model of the virtual character rotates. In this case, the spatial change information includes the rotation information (such as the rotation angle and the rotation direction) of the head model of the virtual character. As shown in a second image shown in FIG. 5, when the virtual character changes from being static facing a side to turning the head and running, the head model of the virtual character not only displaces but also rotates. In this case, the spatial position information includes the displacement information (for example, the displacement direction and the displacement distance) and the rotation information.

Based on the foregoing basic introduction to the static resource data and the spatial change information, after the static resource data of the hair resource of the virtual character in the second game scenario (or the second image frame), and the spatial change information of the virtual character in the world space coordinate system when the virtual character moves from the first game scenario (or the first image frame) to the second game scenario are obtained, the spatial change information may act on the static resource data, to obtain new data through calculation. The new data is spatial position data of the hair resource with global spatial variation (the static resource data includes only a static position of a skin in the head model, and does not include the displacement information, the rotation information, and the like). As described above, the spatial change information may be represented as a matrix, and then the foregoing process of acting the spatial change information on the static resource data may be understood as multiplying the matrix by the static resource data. A possible implementation may include, but is not limited to: determining static position information of the hair resource in the second game scenario from the static resource data, and determining dynamic position information of the hair resource in the second game scenario based on the static position information and the displacement information in the spatial change information. Similarly, the static direction information of the hair resource in the second game scenario is determined from the static resource data, and the dynamic direction information of the hair resource in the second game scenario is determined based on the static direction information and the rotation information in the spatial change information. In this way, the dynamic resource data (that is, the new data) of the hair resource in the second game scenario is formed based on the dynamic position information and the dynamic direction information obtained in the foregoing two operations. The dynamic resource data is configured for reflecting a dynamic characteristic that the hair resource moves with the virtual character. For example, if the virtual character moves to the left, ends of the hair resource move to the left at a movement velocity slightly behind the virtual character, to simulate movement performance of the hair resource moving with the virtual character in the real world.

It can be learned that, the spatial change information generated by the virtual character in the movement process acts on the static resource data of the hair resource of the virtual character in the second image frame, so that the hair resources can be converted from the static resource data to the dynamic resource data, thereby driving the hair resource to follow the movement of the virtual character based on the dynamic resource data to present a corresponding dynamic effect. This manner not only has advantages of simple and convenient calculation, but also can control the movement of the hair resource more accurately, thereby improving the dynamic effect that the hair resource moves with the virtual character in the real world.

Operation S304: Perform physical simulation on the hair resource based on the dynamic resource data.

In the real world, the dynamic effect of hair resource is affected by many factors. In addition to the movement impact of the attached object to which the hair resource is attached, the dynamic effect is also affected by some external factors. The external factors may include, but are not limited to, a wind factor, a gravity factor, and a resistance factor caused by the movement of the attached object. Even if there is an external force pulling the hair resource (for example, the hair resource is hung by an external element (such as a branch or a button)), the hair resource is affected by a pulling force factor. The external factors affected by a hair resource are not limited in this aspect described herein.

Based on this, to make movement performance of the hair resource in the game scenario be as close to movement performance in a similar scenario in the real world as possible, in this aspect described herein, after the dynamic resource data of the hair resource of the virtual character in the second game scenario when the virtual character moves from the first game scenario to the second game scenario is obtained based on the foregoing operations, physical simulation is further performed on the hair resource based on the dynamic resource data. Through the physical simulation, in a process in which the virtual character moves from the first game scenario to the second game scenario, the hair resource can simulate the movement performance in the real environment, thereby improving realism and authenticity of the movement performance of the hair resource. The foregoing external factors act on the hair resource in a form of a constraint condition. For example, if the external factor is the gravity factor, the hair resource is subjected to a constraint condition corresponding to the gravity factor. When the constraint condition acts on the hair resource, the hair resource is subjected to a downward force.

In a possible implementation, after the dynamic resource data of the hair resource of the virtual character in the second game scenario is obtained, one or more constraint conditions to which the virtual character is subjected in the process in which the virtual character moves from the first game scenario to the second game scenario may be obtained. Corresponding to the foregoing described external factors, the constraint conditions herein may include, but is not limited to, a wind constraint, a gravity constraint, a resistance constraint, a length constraint, and the like. Then, physical simulation may be performed on the root vertex of the hair resource based on the one or more constraint conditions and the dynamic resource data. The hair resource is a virtual hair formed by a plurality of chained vertexes, and the root vertex herein is two adjacent vertexes attached to the attached object (for example, the head model of the virtual character) in the hair resource. A principle of performing physical simulation based on the one or more constraint conditions and the dynamic resource data may specifically include: when calculation is performed on a plurality of constraint conditions, simulating a constraint effect that the plurality of constraint conditions affect each other in the real environment, to implement simulation calculation for the plurality of constraint conditions.

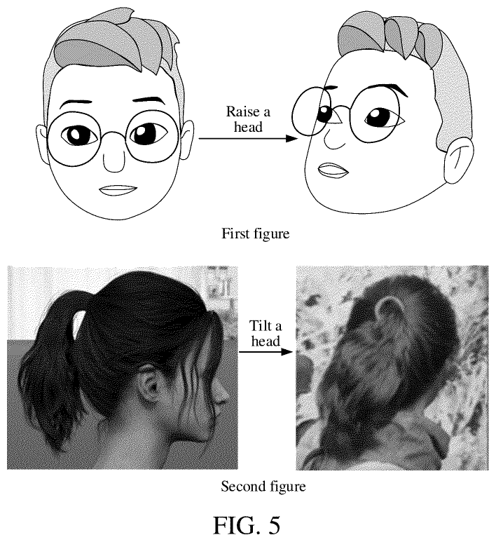

For example, it is assumed that in the process in which the virtual character moves from the first game scenario to the second game scenario, the virtual character is affected by gravity and wind. A wind direction in the wind field shown in FIG. 6 is from right to left. In this case, the hair resource (such as a hair resource 601) of the virtual character may be drooped downward due to the impact of gravity. In addition, considering the impact of wind from right to left, a part of the downward force caused by the impact of gravity is offset, and the tail vertex of the hair resource presents a movement effect to the left, to simulate the movement performance of the hair resource in the real world when the hair resource is affected by wind and gravity.

In conclusion, the spatial change information of the virtual character moving from the first game scenario to the second game scenario is obtained, and the spatial change information acts on the static resource data of the hair resource, so that the dynamic resource data of the hair resource in the second game scenario can be obtained. The dynamic resource data is configured for reflecting the dynamic characteristic that the hair resource moves with the virtual character. In addition, the one or more constraint conditions to which the virtual character is subjected in the process in which the virtual character moves from the first game scenario to the second game scenario can be obtained, and physical simulation is performed on the hair resource through simulation calculation of the one or more constraint conditions and the dynamic resource data. Through the foregoing two aspects, both the dynamic resource data and the one or more constraint conditions may be considered, thereby more accurately controlling the hair resource to dynamically offset with the movement of the virtual character, so that the hair resource in the game world simulates and restores the movement performance of the hair resource in the real world as much as possible, thereby improving naturalness and realism of the hair resource in the game scenario in which the virtual character moves.

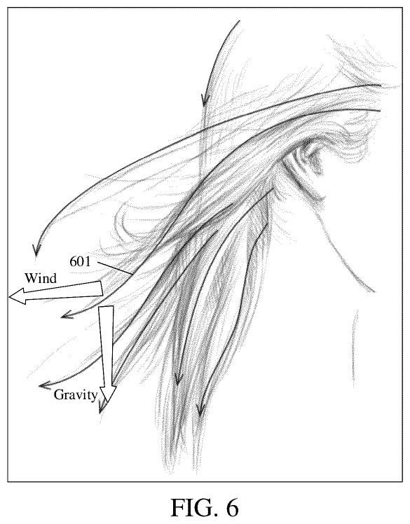

The foregoing aspect shown in FIG. 3 mainly describes an extension part of the TressFx in the resource processing method. The following describes optimized content of the TressFx in the resource processing method in detail with reference to FIG. 7. FIG. 7 is a schematic flowchart of a resource processing method according to an illustrative aspect described herein. The resource processing method may be performed by the computer device described above, and the resource processing method may include, but is not limited to, operations shown in operation S701 to operation S705.

Operation S701: Obtain spatial change information of a virtual character and static resource data of a hair resource of the virtual character in a second game scenario.

For a specific implementation process shown in operation S701 in the aspect shown in FIG. 7, refer to the related descriptions of the specific implementation process shown in operation S301 in the aspect shown in FIG. 3. Details are not described herein again.

Operation S702: Obtain movement information of the virtual character.

Operation S703: Optimize the spatial change information based on the movement information if it is detected that the spatial change information needs to be optimized based on the movement information, to obtain optimized spatial change information.

In operation S702 and operation S703, considering that in some scenarios, if all the spatial change information of moving the virtual character from a first game scenario to the second game scenario acts on the static resource data of the hair resource in the second game scenario, a shape of a fixed-shape hair resource set (for example, a virtual ponytail) formed by a plurality of hair resources may be changed, resulting in an unnatural dynamic effect of the hair resource. For example, the hair resource set of the virtual character is the virtual ponytail. When the virtual character sprints toward a direction, if all the spatial change information of the virtual character in a sprinting process acts on a root vertex of each hair resource included in virtual hair, it is very likely that because a moving velocity is excessively fast (that is, a position change is excessively severe), head hair at the root of the virtual ponytail (that is, a position where the virtual ponytail is tied with a hair tie) is lifted very high, and the effect is unnatural.

Based on this, this aspect described herein supports that after the spatial change information of the virtual character in the world space coordinate system is obtained when the virtual character moves from the first game scenario to the second game scenario, whether the virtual character moves severely this time is first determined. If the movement is not severe, it indicates that acting all the spatial change information on the hair resource does not cause movement unnatural phenomena (such as the root of the ponytail being lifted) of the hair resource, a subsequent operation such as acting the spatial change information on the static resource data is directly performed. On the contrary, if the movement is severe, it indicates that acting the spatial change information on the hair resource causes the movement of the hair resource to be unnatural. In this case, a mechanism can be set to weaken the severe movement caused by the spatial change information, to ensure naturalness and realism of the hair resource.

In this aspect described herein, movement information of the virtual character may be first obtained when the virtual character moves from the first game scenario to the second game scenario. The movement information may include at least one of the following: a displacement distance, a displacement direction, and velocity information. The velocity information may include an average velocity, an acceleration, an angular velocity, and the like.

Then, whether the spatial change information needs to be optimized is detected based on the movement information. A manner of determining whether the spatial change information needs to be optimized may be: 1. If the displacement distance is greater than a displacement distance threshold, it is determined that the spatial change information needs to be optimized. In other words, as long as the displacement distance is greater than the displacement distance threshold, it is determined that the virtual character performs severe movement, and the movement needs to be weakened. 2. If the displacement distance is less than or equal to a displacement distance threshold, the displacement direction indicates that the movement direction of the virtual character in the first game scenario is different from the movement direction of the virtual character in the second game scenario, and the velocity information indicates that a velocity of the virtual character is greater than a velocity threshold, it is determined that the spatial change information needs to be optimized. The case described above can be imagined as a case in which the virtual character first runs toward a direction, and then quickly runs in an opposite direction of the direction. In this case, the virtual character in the first image frame moves in a direction, and the virtual character in the second image suddenly moves in an opposite direction of the direction. In this case, direction inertia is involved in this case, and a mechanism needs to be set to make a direction change process not abrupt and without model penetration. Specific values of various thresholds described above (such as the displacement distance threshold and the velocity threshold) may be obtained based on a test to obtain appropriate values, and the aspects described herein do not limit the specific values of the thresholds.

Finally, if it is determined that the spatial change information needs to be optimized, that is, the movement of the virtual character is severe, resulting in an unnatural movement process of the hair resource, so that the spatial change information may be optimized, to alleviate phenomena such as model penetration and unnaturalness caused by severe movement to the hair resource. For example, a movement threshold corresponding to the movement information may be obtained. For example, if the movement information is the displacement distance, the movement threshold is the displacement distance threshold. For example, if the movement information is the velocity information, the movement threshold is the velocity threshold. Then, a constraint condition is added to the virtual character based on difference information between the movement information and the movement threshold. In other words, a degree of the severe movement is measured through the difference information between the movement information and the movement threshold, so that the constraint condition is added for the virtual character based on the degree. The spatial change information is optimized based on the added constraint condition. Specifically, the displacement information and the rotation information that are included in the spatial position information are updated, to obtain optimized spatial position information. New position information and new rotation information that are included in the optimized spatial position information act on the static resource data, to obtain dynamic resource data. In this case, this does not cause the phenomena such as model penetration and unnaturalness of the hair resource to be generated when the virtual character moves severely, thereby restoring a natural movement effect of the hair resource in a severe movement scenario.

It can be learned that, after the spatial change information of the virtual character is obtained when the virtual character moves from the first game scenario to the second game scenario, first, the spatial change information does not act on the static resource data of the hair resource of the virtual character in the second game scenario, but whether the virtual character moves severely is first determined, and the spatial change information is optimized when the virtual character moves severely. In this manner, when the severe movement of the virtual character can be effectively avoided, the spatial change information completely acts on the phenomena such as model penetration and unnaturalness of the hair resource caused by the static resource data.

In the foregoing process of optimizing the spatial change information, the movement information of the virtual character moving from the first game scenario to the second game scenario is re-obtained to determine whether the spatial change information needs to be optimized. As described above, the spatial change information includes the displacement information and the rotation information of the virtual character when the virtual character moves from the first game scenario to the second game scenario. Therefore, in a specific determining process, the movement information of the virtual character might not be obtained again, but information such as a displacement and/or a velocity (for example, an acceleration and/or an angular velocity) may be analyzed from the spatial change information for determining. A specific implementation of determining whether the spatial change information needs to be optimized, that is, whether the virtual character moves severely, is not limited in this aspect described herein. This is specifically described herein.

Operation S704: Obtain the dynamic resource data of the hair resource in the second game scenario based on the static resource data and the optimized spatial change information.

A specific implementation process of acting the optimized spatial change information on the static resource data to obtain the dynamic resource data is similar to a specific implementation process of acting original spatial change information in the static resource data to obtain the dynamic resource data shown in operation S303 in the aspect shown in FIG. 3. Only specific values (such as values of elements included in the matrix) of the optimized spatial change information are different from specific values of the original spatial change information. Details are not described herein again.

Operation S705: Perform physical simulation on the hair resource based on the dynamic resource data.

For a specific implementation process shown in operation S705, refer to related descriptions of the specific implementation process shown in operation S304 in the aspect shown in FIG. 3. Details are not described herein again.

The resource processing solution provided in this aspect described herein is to expand and optimize the TressFx. Operation S701 to operation S705 mainly provide specific implementation content of adding world space in the TressFx. Optimization for the TressFx is described below.

### (1) Optimization for Parameter Control and a Local Shape Constraint

1. Parameter control: In a process of performing physical simulation on the hair resource of the virtual character, the TressFx mainly implements the physical simulation by providing a group of parameters. The parameters herein may include parameters of various constraint conditions, such as a parameter of a gravity (G) constraint and a parameter of an air resistance (that is, resistance to which the object is subjected when moving in air). In an actual application, if only parameter values of the parameters of the constraint conditions in the real world are brought into simulation calculation for the hair resource, not only a calculation amount is large, but also a calculation effect is poor. Based on this, the aspects described herein support considering an association between the parameters, for example, parameters that affect each other are associated or integrated together, so that an art party (a user drawing the hair resource) conveniently adjusts a plurality of parameters in a linked manner, thereby reducing calculation overheads and improving simulation calculation accuracy. For example, in some scenarios, a change can be unified into stiffness deformation to avoid extra computational overheads of calculating both a flexibility change and the stiffness deformation.

In a possible implementation, in a physical simulation process for the hair resource of the virtual character, a parameter group needed for drawing the hair resource may be obtained, and the parameter group includes the plurality of parameters. Then, association analysis is performed on the plurality of parameters in the parameter group. The association analysis is mainly performed on the plurality of parameters by following principles of whether the parameters affect and interact with each other in the real world and whether different parameters can be integrated, to obtain an association relationship between the parameters in the parameter group. Finally, the art party may determine the parameter values of the parameters in the virtual world (or the game world) based on the parameter values of the parameters in the parameter group in the real world and the association relationship between the parameters. In this way, associated or integrated parameters may be used to draw the hair resource, to obtain a hair resource with better quality and higher realism.

2. The local shape constraint is modified: The local shape constraint in the TressFx is mainly configured for calculating a position of a vertex of the hair resource after being affected by adjacent front and rear vertexes, and calculation operations of the local shape constraint is implemented based on initialized static data (which may be simply understood as an initial position) of the vertex on the hair resource (strand). Considering the movement performance of the hair resource moving with the movement of the virtual character needs to be simulated, the technology of performing local shape constraint by using the initialized static data of the hair resource causes a poor simulation effect. Therefore, in the aspects described herein, when the local shape constraint is calculated for the hair resource, skinning data in the image frame after the virtual character moves is obtained for calculating of the local shape constraint. Compared with calculation based on the static data, a hair simulation effect of in the movement process can be better and more natural.

(2) Optimization for the Virtual Ponytail (Or a Fixed-Shape Hair Style Such as a Virtual Braid or a Virtual Bun) Formed by the Plurality of Hair Resources

When a simulated virtual character in the TressFx performs squatting action (or another movement that may cause the virtual character to quickly change a position in a vertical direction (such as vertical take-off)), the virtual ponytail of the virtual character may possibly have problems such as being lifted, lacking the sense of drape, lengthening, easily spreading out, and collision detection.

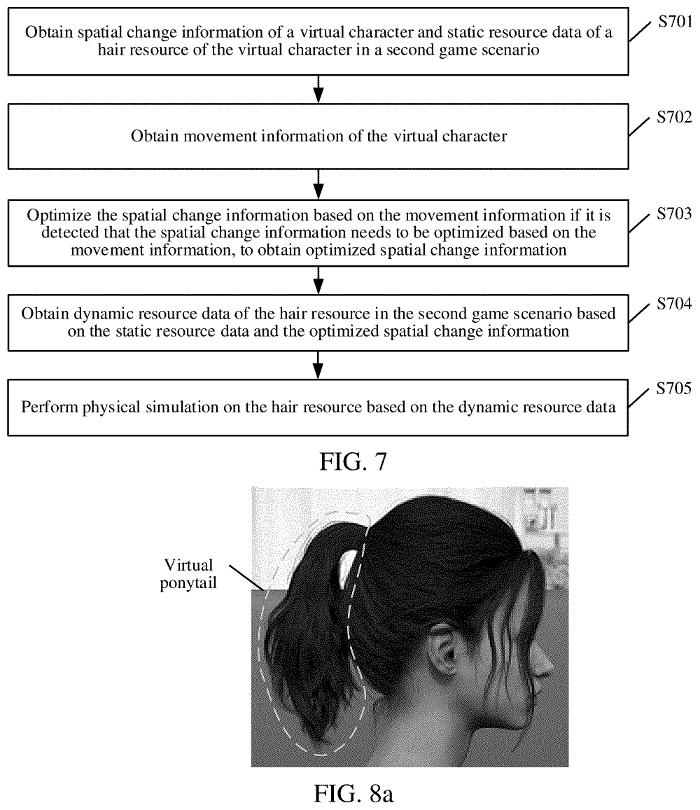

1. For the problem that the virtual ponytail (or an end part of the virtual braid) is easily spreading out: Considering that the local shape of the hair resource is ensured through the local shape constraint in the TressFx, in the aspects described herein, the local shape constraint is mainly optimized, to control the virtual ponytail from spreading out through the optimized local shape constraint. In a possible implementation, the local shape constraint of the hair resource set (that is, the virtual ponytail) is obtained, and the local shape constraint is updated by using a first identification coefficient. The updating herein is specifically adding the first identification coefficient to the local shape constraint. The first identification coefficient is mainly configured for identifying which part of the virtual ponytail is a hair resource that easily spreads out. Then, identification processing is performed on the hair resource set by using an updated local shape constraint, to obtain a first hair set in the hair resource set. A hair spreading probability of the hair resource in the first hair set is greater than a preset threshold. For example, when the hair resource set is the virtual ponytail, an identified first hair set is the entire virtual ponytail (as shown in FIG. 8a). For another example, when the hair resource set is the virtual braid, the identified first hair set is some hair resources following a hair tie of the virtual braid (as shown in FIG. 8b). Finally, constraint processing is performed on each hair resource in the first hair set, to obtain a constraint hair set. A hair spreading probability of each hair resource in the constraint hair set is less than or equal to the preset threshold, so that a constrained constraint hair set keeps a fixed shape or does not easily spread out in a process in which the virtual character performs squatting action.

2. For problems that the virtual ponytail is lifted and lacks the sense of drape: Similar to the implementation 1, the local shape of the hair resource is ensured through the local shape constraint in the TressFx. Therefore, first, the local shape constraint of the hair resource set may be obtained, and the local shape constraint is updated by using a second identification coefficient, to obtain an updated local shape constraint. The second identification coefficient is configured for identifying some hair resources in the hair resource set that need to avoid being lifted or lacking the sense of drape (for example, a root of the virtual ponytail, as shown in FIG. 8c). Then, identification processing is performed on the hair resource set by using an updated local shape constraint, to obtain a second hair set in the hair resource set. The second hair set is a root resource set (for example, a ponytail root of the virtual ponytail) or a tail resource set (for example, an end part of the virtual ponytail and the virtual braid) of the hair resource set. In addition, an acceleration of a vertex of the hair resource in the second hair set is obtained, and whether the acceleration is greater than an acceleration threshold is determined. If the acceleration is greater than the acceleration threshold, it indicates that the identified second hair set may possibly generate the problems that the virtual ponytail is lifted and lacks the sense of drape, and this part of the hair resource needs to be processed, to avoid the problems that the virtual ponytail is lifted and lacks the sense of drape. For example, a global movement parameter of the hair resource set may be obtained, weighted processing is performed on the global movement parameter by using an attribute value, to obtain a weighted processing result, and the weighted processing result is determined as a vertex movement parameter of the vertex of the hair resource in the second hair set. The vertex movement parameter is configured for controlling a movement effect of the vertex.

Considering that when an attached object (for example, the virtual character) moves, a velocity shock propagation (VSP) in the TressFx is mainly used to control, through an involved acceleration, the hair resource to move. Therefore, in the aspects described herein, the VSP may be improved, so that the second hair set is processed by using an improved VSP, to avoid the problems that the virtual ponytail is lifted and lacks the sense of drape. The VSP in the TressFx is global, that is, VSPs of vertexes (mainly root vertexes) in all hair resources of the virtual character are the same, that is, a VSP value is valid for each vertex. To implement differentiation the VSP value of the vertex, so that different vertexes follow the movement of the virtual character and present different following states, the aspects described herein supports setting an elasticity attribute (whose value is in a range of [0, 1]) for the vertexes in the hair resource. Specifically, the elasticity attribute may be set for each vertex or some vertexes (for example, root vertexes) in the hair resource, to adjust the VSP value of the vertex through the elasticity attribute, and accurately control the VSP of each vertex, thereby avoiding the problems that the ponytail is lifted and lacks the sense of drape. After it is determined that the acceleration of the vertex of the hair resource is greater than the acceleration threshold, an attribute value of the elasticity attribute may be determined for the vertex based on the acceleration, for example, the attribute value is 0.3. Then, the global movement parameter (that is, the VSP) of the hair resource set is obtained, and weighted processing is performed on the global movement parameter by using the attribute value, to obtain a weighted processing result 0.3*VSP. Finally, the weighted processing result is used as the vertex movement parameter of the vertex of the hair resource in the second hair set. In this way, the vertex movement parameter of the vertex in each hair resource is accurately controlled, to control a movement effect of the corresponding vertex through the vertex movement parameter.

3. For the problem that the hair resource is easily lengthened: The length of the hair resource is controlled by introducing a length constraint to the TressFx. Therefore, in the aspects described herein, the length of the hair resource is better controlled by strengthening the length constraint, to simulate the length of the hair resource in the real world and keep the length fixed. The length constraint may be strengthened by adjusting a calculation sequence of a plurality of constraint conditions of the hair resource. For example, the plurality of constraint conditions for the hair resource of the virtual character are obtained, the constraint conditions include at least a length constraint, and the constraint conditions are calculated iteratively. In this way, in a process of sequentially calculating the plurality of constraint conditions, a calculation sequence of the plurality of constraint conditions is adjusted, so that an adjusted length constraint is located at a tail calculation position in a calculation process. In other words, an original calculation position of the length constraint may be adjusted from a front calculation position to a rear calculation position, thereby avoiding a defect of weak length control strength for the hair resource after the length constraint is calculated prematurely. In addition, a constraint formula of the length constraint may be corrected. Specifically, the constraint formula of the length constraint is obtained, and a constraint parameter is added to the constraint formula, the constraint parameter being configured for correcting the length of the hair resource of the virtual character after movement. Adding the constraint parameter to the constraint formula of the length constraint is similar to adding a stiffness coefficient. The stiffness coefficient enables the length constraint to pull the length of the hair resource backward as much as possible. For example, an original distance between two vertexes is 10 cm, and a corrected distance is 9 cm. Certainly, values of the stiffness coefficients of different hair resources may be different.

4. For the problem of the collision detection: With movement of the virtual character, the hair resource of the virtual character collides with an object in the virtual environment or an object (such as a hair accessory) of the virtual character. In this case, effectively performing collision detection and implementing correction under collision (that is, making a collided hair resource present a natural collision state) is beneficial to improving realness of the hair resource. In the TressFx, collision detection and correction are mainly implemented based on a signed distance field (SDF). SDF-based collision correction includes two parts: displaying that a directed distance field is established between the hair resource and a to-be-collided object, and then performing collision detection and correction in the directed distance field by using a calculation result (for example, a calculation result of the simulation calculation) for the hair resource. However, it is found through practice that the SDF is very energy-consuming, and the more hair resources there are, the more energy the SD consumes. Therefore, in the aspect described hereins, after the TressFx is integrated into the in-house developed rendering engine, the SDF is discarded, and a collision problem is resolved based on a capsule. A basic idea of resolving the collision problem by the capsule is simplifying the collision problem into spherical collision by solving closest points of two segments (for example, the hair resource and a side that is in the to-be-collided object and that collides with the hair resource).

### (3) Optimization for a VSP Calculation Process

Considering that calculation overheads of the VSP in the TressFx are large, in the aspects described herein, the vertexes of the hair resource are divided into two parts: a global vertex and a local vertex. A parameter value of a VSP of the global vertex is set to 0. Therefore, a VSP operation does not need to be performed, and VSP calculation is still performed on the local vertex. In this manner of simplifying VSP calculation of some vertexes, some VSP calculation is effectively reduced, thereby reducing VSP calculation overheads. An idea for optimizing the VSP calculation process mainly includes: in a process of calculating the global movement parameter VSP of the hair resource set through a thread, obtaining a hair resource processed by the thread, and performing hair identification processing on the hair resource, to obtain an identification result of the hair resource. The identification result indicates that the hair resource is a guide strand or a follow strand, and the follow strand is obtained by offsetting the guide strand, or the identification result indicates that the vertex in the corresponding hair resource is a root vertex or a non-root vertex of the hair resource, and the root vertex and an attached object of the hair resource remain relatively fixed. In other words, whether a vertex of the hair resource processed by a current thread is the root vertex is first checked, or whether the hair resource is the follow strand is checked.

Then, if the identification result indicates that the hair resource is the follow strand, or the identification result indicates that the vertex corresponding to the hair resource is the root vertex of the hair resource, the identification result is directly returned, that is, the processing of the current thread is interrupted or omitted. On the contrary, if the identification result indicates that the hair resource is the follow strand, or the identification result indicates that the vertex corresponding to the hair resource is the non-root vertex of the hair resource, the processing of the thread continues. Specifically, parameters (including a rotation quaternion, a translation vector, a coefficient, and the like) needed for the VSP calculation are obtained, a new position and an old position of a current vertex before and after the movement are obtained, and whether a change of the current vertex in the z coordinate of the world space coordinate system is excessively large is detected. If the change is excessively large, the identification result is returned directly, that is, the processing of the current thread is interrupted or omitted. If the change is not excessively large, save the new position and the old position of the current vertex before and after the movement into a field HairVertexPositions and a field HairVertexPositionsPrev.

### (4) Optimization for Hair Manufacture

In the aspects described herein, some original generation policies of the hair resource in the TressFx are optimized, to improve hair manufacturing efficiency, help an artist quickly create a hair resource that satisfies a requirement, and ensure quality and reliability of the hair resource. For example, in the aspects described herein, the generation policy may be modified to avoid a problem of a poor hair resource rendering effect caused by overlapping rendering of the redundant hair resource. In a possible implementation, first, a quantity K of to-be-produced hair resources is obtained, K being a positive integer. Then, the quantity K is divided into m generation groups, k hair resources are generated in parallel in each generation group, m*k≥K, and m and k are positive integers. If m*k>K, redundant m*k−K hair resources are obtained from an m^{th} generation group of the m generation groups. Finally, the m*k−K hair resources are set to a hidden state, the hidden state indicating that the m*k−K hair resources are hidden during rendering.

For example, the TressFx supports relying on a parallel processing capability of a GPU, and k=64 hair resources can be generated in parallel each time. In an actual application, a quantity of hair resources is usually not an integer of 64. If a quantity of to-be-generated hair resources is K=126, the 126 hair resources may be divided into two generation groups, and the 64 hair resources are generated in each generation group. In a hair resource rendering process, the 64 hair resources generated by a first generation group may all be rendered based on a rendering requirement (such as a rendering position and a rendering direction) of each hair resource, and m*k−K=2 hair resources existing in the 64 hair resources generated by a second generation group are redundant. In an original TressFx, the two redundant hair resources are overlapped rendered to a last hair resource in the 126 hair resources. Consequently, from a visual effect, the last hair resource may have unnatural problems such as goof, a darker color, or a thicker width. However, in the aspects described herein, display space of the two redundant hair resources is changed, to set the two redundant hair resources to the hidden state, so that the set two hair resources are hidden during rendering, and the last hair resource is prevented from being unnatural.

In conclusion, in the aspects described herein, world space simulation is added to the TressFx to implement extension of the TressFx. The spatial change information of the virtual character acts on the static resource data of the hair resource when the virtual character moves from the first game scenario to the second game scenario, to obtain the dynamic resource data of the hair resource in the second game scenario. Therefore, based on the dynamic resource data, the hair resource can be more accurately controlled to dynamically offset with the movement of the virtual character, and impact of factors such as gravity, air resistance, and displacement of the actor acting on the hair resource in a movement process can be simulated more accurately, so that the hair resource is more naturally presented in aspects such as fluttering, lateral movement, and fine hair dynamics, and the hair resource in the game world simulates and restores the movement performance of the hair resource in the real world as much as possible. In addition, in the aspects described herein, some original solutions in the TressFx are optimized, for example, to resolve the problems that the virtual ponytail is easily to be lifted, spreads out, lacks the sense of drape, is lengthened, and the like, thereby ensuring that the virtual ponytail can keep an overall shape with the movement of the virtual character, and presenting more real and natural movement performance.

The foregoing describes the method in the aspects described herein in detail. For ease of better implementing the foregoing solutions in the aspects described herein, correspondingly, the following provides an apparatus in the aspects described herein.

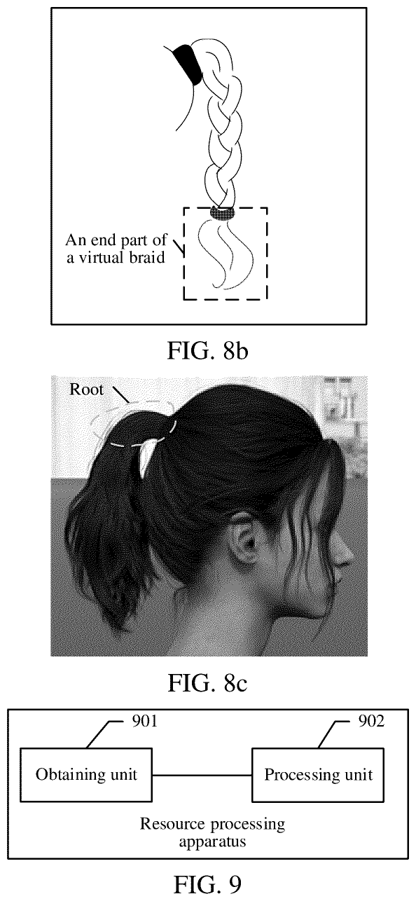

FIG. 9 is a schematic structural diagram of a resource processing apparatus according to an illustrative aspect described herein. The resource processing apparatus may be configured to perform some or all operations in the method aspect shown in FIG. 3 or FIG. 7. Referring to FIG. 9, the resource processing apparatus includes the following units:
an obtaining unit 901, configured to obtain spatial change information of a virtual character, the spatial change information indicating a position change of the virtual character in a world space coordinate system when the virtual character moves from a first game scenario to a second game scenario;
the obtaining unit 901, further configured to obtain static resource data of a hair resource of the virtual character in the second game scenario, the static resource data being configured for reflecting a static characteristic of the hair resource when the virtual character is in a static state in the second game scenario;
a processing unit 902, configured to obtain dynamic resource data of the hair resource in the second game scenario based on the static resource data and the spatial change information, the dynamic resource data being configured for reflecting a dynamic characteristic that the hair resource moves with the virtual character; and
the processing unit 902, further configured to perform physical simulation on the hair resource based on the dynamic resource data, the physical simulation being configured for controlling the hair resource to simulate movement performance in a real world in a process in which the virtual character moves from the first game scenario to the second game scenario.

In an implementation, one game scenario corresponds to one image frame, and the image frame is configured for describing the game scenario from an image dimension, and when obtaining spatial change information of a virtual character, the obtaining unit 901 is specifically configured to:
obtain a first image frame corresponding to the first game scenario, and calculate first spatial position information of the virtual character in the first image frame in the world space coordinate system;
obtain a second image frame corresponding to the second game scenario, and calculate second spatial position information of the virtual character in the second image frame in the world space coordinate system; and
calculate the spatial change information of the virtual character based on the first spatial position information and the second spatial position information.

In an implementation, the spatial change information includes displacement information and rotation information, the dynamic resource data of the hair resource in the second game scenario includes dynamic position information and dynamic direction information, and when obtaining dynamic resource data of the hair resource in the second game scenario based on the static resource data and the spatial change information, the processing unit 902 is specifically configured to:
determine static position information of the hair resource in the second game scenario from the static resource data, and determine the dynamic position information of the hair resource in the second game scenario based on the static position information and the displacement information in the spatial change information; and
determine static direction information of the hair resource in the second game scenario from the static resource data, and determine the dynamic direction information of the hair resource in the second game scenario based on the static direction information and the rotation information in the spatial change information.

In an implementation, when performing physical simulation on the hair resource based on the dynamic resource data, the processing unit 902 is specifically configured to:
obtain one or more constraint conditions to which the virtual character is subjected in the process in which the virtual character moves from the first game scenario to the second game scenario, the constraint condition including at least one of the following: a gravity constraint, a length constraint, or a resistance constraint; and
perform physical simulation on a root vertex of the hair resource based on the one or more constraint conditions and the dynamic resource data, the hair resource being a virtual hair formed by a plurality of chained vertexes, and the root vertex being two adjacent vertexes attached to an attached object in the hair resource.

In an implementation, the processing unit 902 is further configured to:
obtain movement information of the virtual character, the movement information including at least one of the following: a displacement distance, a displacement direction, and velocity information; and
optimize the spatial change information based on the movement information, to obtain optimized spatial change information if it is detected that the spatial change information needs to be optimized based on the movement information, if the displacement distance is greater than a displacement distance threshold, the spatial change information needing to be optimized, or if the displacement distance is less than or equal to a displacement distance threshold, the displacement direction indicating that a movement direction of the virtual character in the first game scenario is different from a movement direction of the virtual character in the second game scenario, and the velocity information indicating that a velocity of the virtual character is greater than a velocity threshold, the spatial change information needing to be optimized.

When obtaining dynamic resource data of the hair resource in the second game scenario based on the static resource data and the spatial change information, the processing unit 902 is specifically configured to:
obtain the dynamic resource data of the hair resource in the second game scenario based on the static resource data and the optimized spatial change information.

In an implementation, when optimizing the spatial change information based on the movement information, to obtain optimized spatial change information, the processing unit 902 is specifically configured to:
obtain a movement threshold corresponding to the movement information;
add a constraint condition to the virtual character based on difference information between the movement information and the movement threshold; and
optimize the spatial change information based on the constraint condition, to obtain the optimized spatial change information.

In an implementation, the hair resource is a virtual hair attached to the virtual character, the virtual hair is formed by a plurality of strand segments connected in a chain manner, and each strand segment is formed by two vertexes connected through a virtual spring.

In an implementation, the processing unit 902 is further configured to:
obtain a plurality of constraint conditions for the hair resource of the virtual character, the plurality of constraint conditions including at least a length constraint, and the length constraint being configured for controlling a length of the hair resource to remain unchanged in a movement process of the virtual character;
adjust a calculation sequence of the plurality of constraint conditions in a process of sequentially calculating the plurality of constraint conditions, to enable an adjusted length constraint to be located at a tail calculation position in a calculation process; and
obtain a constraint formula of the length constraint, and add a constraint parameter to the constraint formula, the constraint parameter being configured for correcting a length of the hair resource of the virtual character after the movement.

In an implementation, the processing unit 902 is further configured to:
obtain a local shape constraint of the hair resource set, and update the local shape constraint by using a first identification coefficient;
perform identification processing on the hair resource set by using an updated local shape constraint, to obtain a first hair set in the hair resource set, a hair spreading probability of the hair resource in the first hair set being greater than a preset threshold; and
perform constraint processing on each hair resource in the first hair set, to obtain a constraint hair set, a hair spreading probability of each hair resource in the constraint hair set being less than or equal to the preset threshold.

In an implementation, a vertex of the hair resource is set with an elasticity attribute, and the processing unit 902 is further configured to:
obtain a local shape constraint of the hair resource set, and update the local shape constraint by using a second identification coefficient;
perform identification processing on the hair resource set by using an updated local shape constraint, to obtain a second hair set in the hair resource set, the second hair set being a root resource set or a tail resource set of the hair resource set;
obtain an acceleration of a vertex of the hair resource in the second hair set;
determine an attribute value of the elasticity attribute for the vertex based on the acceleration if the acceleration is greater than an acceleration threshold;
obtain a global movement parameter of the hair resource set, and perform weighted processing on the global movement parameter by using the attribute value, to obtain a weighted processing result; and
determine the weighted processing result as a vertex movement parameter of the vertex of the hair resource in the second hair set, the vertex movement parameter being configured for controlling a movement effect of the vertex.

In an implementation, the processing unit 902 is further configured to:
obtain, in a process of calculating the global movement parameter of the hair resource set through a thread, a hair resource processed by the thread, and perform hair identification processing on the hair resource, to obtain an identification result of the hair resource, the identification result indicating that the hair resource is a guide strand or a follow strand, and the follow strand being obtained by offsetting the guide strand; or the identification result indicating that the vertex corresponding to the hair resource is a root vertex or a non-root vertex of the hair resource, and the root vertex and an attached object of the hair resource remaining relatively fixed; and
interrupt processing of the thread if the identification result indicates that the hair resource is the follow strand or the identification result indicates that the vertex corresponding to the hair resource is the root vertex of the hair resource; or
continue processing of the thread if the identification result indicates that the hair resource is the guide strand or the identification result indicates that the vertex corresponding to the hair resource is the non-root vertex of the hair resource.

In an implementation, the processing unit 902 is further configured to:
obtain a quantity K of to-be-produced hair resources, K being a positive integer;
divide the quantity K into m generation groups, k hair resources being generated in parallel in each generation group, m*k≥K, and m and k being positive integers;
obtain, if m*k>K, m*k−K hair resources from an m^{th} generation group of the m generation groups; and
set the m*k−K hair resources to a hidden state, the hidden state indicating that the m*k−K hair resources are hidden during rendering.

In an implementation, the processing unit 902 is further configured to:
obtain a parameter group needed for drawing the hair resource, the parameter group including a plurality of parameters;
perform association analysis on the plurality of parameters in the parameter group, to obtain an association relationship between the parameters in the parameter group; and
determine a parameter value of each parameter in a virtual world based on a parameter value of each parameter in a real world and the association relationship between the parameters.

According to an aspect described herein, the units in the resource processing apparatus shown in FIG. 9 may be separately or entirely combined into one or several other units, or one (or more) of the units may further be divided into a plurality of units of smaller functions. In this way, same operations can be implemented without affecting implementation of the technical effects of the aspects described herein. The foregoing units are divided based on logical functions. In an actual application, a function of one unit may also be implemented by a plurality of units, or functions of a plurality of units are implemented by one unit. In other aspects described herein, the resource processing apparatus may also include another unit. In an actual implementation, these functions may also be implemented with assistance by another unit, and may be implemented with cooperation by a plurality of units. According to another aspect described herein, the resource processing apparatus shown in FIG. 9 may be constructed and the resource processing method in the aspects described herein may be implemented by running a computer program (including program code) that can perform the operations involved in the corresponding methods shown in FIG. 3 and FIG. 7 on a general-purpose computing device such as a computer that includes processing elements and storage elements such as a central processing unit (CPU), a random access storage medium (RAM), and a read-only storage medium (ROM). The computer program may be recorded in, for example, a computer-readable recording medium, and may be loaded into the computer device by using the computer-readable recording medium and run in the computer device.

In the aspects described herein, the spatial change information of the virtual character in the world space coordinate system may be obtained when the virtual character moves from the first game scenario to the second game scenario, and the spatial change information reflects a position change of the virtual character when moving in the world space. Then, acting the spatial change information on the static resource data of the hair resource of the virtual character in the second game scenario is supported, to obtain the dynamic resource data of the hair resource in the second game scenario, the static resource data being configured for reflecting a static characteristic of the hair resource when the virtual character in the second game scenario is in a static state, and the dynamic resource data being configured for reflecting a dynamic characteristic that the hair resource moves with the virtual character. Finally, physical simulation may be performed on the hair resource based on the dynamic resource data of the hair resource. The physical simulation enables the hair resource to simulate movement performance in the real world in the process in which the virtual character moves from the first game scenario to the second game scenario. It can be learned that, in the aspects described herein, world space simulation is added to the TressFx. The spatial change information of the virtual character moving from the first game scenario to the second game scenario acts on the static resource data of the hair resource, to obtain the dynamic resource data of the hair resource in the second game scenario, thereby more accurately controlling, based on the dynamic resource data, the hair resource to dynamically offset with the movement of the virtual character, so that the hair resource in the game world simulates and restores movement performance of the hair resource in the real world as much as possible, thereby improving naturalness and realism of the hair resource in the game scenario in which the virtual character moves.

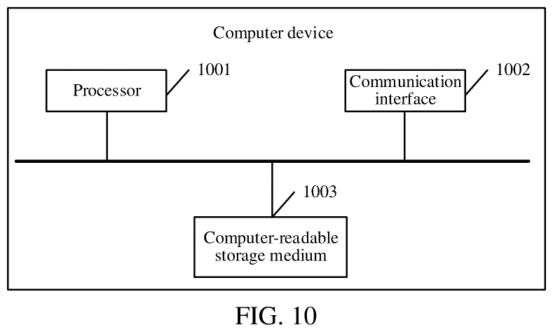

FIG. 10 is a schematic structural diagram of a computer device according to an illustrative aspect described herein. Referring to FIG. 10, the computer device includes a processor 1001, a communication interface 1002, and a computer-readable storage medium 1003. The processor 1001, the communication interface 1002, and the computer-readable storage medium 1003 may be connected through a bus or in another manner. The communication interface 1002 is configured to receive and transmit data. The computer-readable storage medium 1003 may be stored in a memory of the computer device. The computer-readable storage medium 1003 is configured to store a computer program. The computer program includes program instructions. The processor 1001 is configured to execute the program instructions stored in the computer-readable storage medium 1003. The processor 1001 (or referred to as a central processing unit (CPU)) is a computing core and a control core of the computer device, is applicable for implementing one or more instructions, and is specifically applicable for loading and executing one or more instructions to implement a corresponding method process or a corresponding function.

The aspects described herein further provide a computer-readable storage medium (memory). The computer-readable storage medium is a storage device in the computer device, and is configured to store a program and data. The computer-readable storage medium herein may include a built-in storage medium in the computer device, and certainly may also include an extended storage medium supported by the computer device. The computer-readable storage medium provides a storage space, and the storage space stores a processing system of the computer device. In addition, the storage space further stores one or more instructions applicable to be loaded and executed by the processor 1001. The instructions may be one or more computer programs (including program code). The computer-readable storage medium herein may be a high-speed RAM memory, or may be a non-volatile memory, for example, at least one magnetic disk memory. In some aspects, the medium may further be at least one computer-readable storage medium located far away from the foregoing processor.

In an aspect, the computer-readable storage medium stores one or more instructions. The processor 1001 loads and executes the one or more instructions stored in the computer-readable storage medium, to implement corresponding operations in the foregoing resource processing method aspect. During specific implementation, the one or more instructions in the computer-readable storage medium are loaded by the processor 1001 to perform the method described in the foregoing aspects.

Based on a same inventive concept, a principle and a beneficial effect of the problem solution of the computer device provided in the aspects described herein are similar to a principle and a beneficial effect of a problem solution of the resource processing method in the method aspect described herein. Reference may be made to a principle and a beneficial effect of implementation of the method. For concise description, details are not described herein again.

An aspect described herein further provides a computer program product, the computer program product includes a computer program, and the computer program is stored in a computer-readable storage medium. The processor of the computer device reads the computer program from the computer-readable storage medium, and the processor executes the computer program, so that a terminal performs the foregoing resource processing method.

A person of ordinary skill in the art may be aware that, in combination with the examples described in aspects disclosed in this application, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but such implementation is not to be considered outside of the scope described herein.

All or a part of foregoing aspects may be implemented by using software, hardware, firmware, or any combination thereof. When software is configured to implement aspects, all or a part of aspects may be implemented in a form of a computer program product. The computer program product includes one or more computer instructions. When the computer program instructions are loaded and executed on a computer, all or some of the procedures or functions according to the aspects described herein are generated. The computer may be a general-purpose computer, a dedicated computer, a computer network, or another programmable device. The computer instructions may be stored in the computer-readable storage medium or transmitted through the computer-readable storage medium. The computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium that can be accessed by the computer, or a data processing device, such as a server or a data center in which one or more usable mediums are integrated. The usable medium may be a magnetic medium (for example, a soft disk, a hard disk, or a magnetic tape), an optical medium (for example, a DVD), a semiconductor medium (for example, a solid state disk (SSD)), or the like.

The foregoing descriptions are merely specific implementations described herein, but are not intended to limit the protection scope described herein. Any variation or replacement readily figured out by a person skilled in the art within the technical scope disclosed in this application shall fall within the protection scope described herein. Therefore, the protection scope described herein shall be subject to the protection scope of the claims.

What is claimed is:

1. A resource processing method, the method being executed by a computer device, and comprising:
determining that a virtual character changes position within a world space coordinate system when the virtual character moves from a first game scenario to a second game scenario;
obtaining static resource data of a hair resource of the virtual character in the second game scenario, the static resource data being configured for reflecting a static characteristic of the hair resource associated with the virtual character when the virtual character is in a static state in the second game scenario;
obtaining dynamic resource data of the hair resource in the second game scenario based on the static resource data and the position change of the virtual character, the dynamic resource data being configured for reflecting a dynamic characteristic that the hair resource moves with the virtual character; and
performing physical simulation on the hair resource based on the dynamic resource data, the physical simulation being configured for controlling the hair resource to simulate hair movement during a process in which the virtual character moves from the first game scenario to the second game scenario.

2. The method according to claim 1, wherein one game scenario corresponds to one image frame, and the image frame is configured for describing the game scenario from an image dimension, and the determining comprises:
obtaining a first image frame corresponding to the first game scenario, and calculating first spatial position information of the virtual character in the first image frame in the world space coordinate system;
obtaining a second image frame corresponding to the second game scenario, and calculating second spatial position information of the virtual character in the second image frame in the world space coordinate system; and
calculating the spatial change information of the virtual character based on the first spatial position information and the second spatial position information.

3. The method according to claim 1, wherein the determining comprises determining displacement information and rotation information, the dynamic resource data of the hair resource in the second game scenario comprises dynamic position information and dynamic direction information, and
wherein the obtaining dynamic resource data of the hair resource in the second game scenario based on the static resource data and the spatial change information comprises:
determining static position information of the hair resource in the second game scenario from the static resource data, and determining the dynamic position information of the hair resource in the second game scenario based on the static position information and the displacement information in the spatial change information; and
determining static direction information of the hair resource in the second game scenario from the static resource data, and determining the dynamic direction information of the hair resource in the second game scenario based on the static direction information and the rotation information in the spatial change information.

4. The method according to claim 1, wherein the performing physical simulation on the hair resource based on the dynamic resource data comprises:
obtaining one or more constraint conditions to which the virtual character is subjected in the process in which the virtual character moves from the first game scenario to the second game scenario, the constraint condition comprising at least one of the following: a gravity constraint, a length constraint, or a resistance constraint; and
performing physical simulation on a root vertex of the hair resource based on the one or more constraint conditions and the dynamic resource data, the hair resource being a virtual hair formed by a plurality of chained vertexes, and the root vertex being two adjacent vertexes attached to an attached object in the hair resource.

5. The method according to claim 1, further comprising:
obtaining movement information of the virtual character, the movement information comprising at least one of the following: a displacement distance, a displacement direction, and velocity information;
optimizing the spatial change information based on the movement information, to obtain optimized spatial change information if it is detected that the spatial change information needs to be optimized based on the movement information, if the displacement distance is greater than a displacement distance threshold, the spatial change information needing to be optimized, or if the displacement distance is less than or equal to a displacement distance threshold, the displacement direction indicating that a movement direction of the virtual character in the first game scenario is different from a movement direction of the virtual character in the second game scenario, and the velocity information indicating that a velocity of the virtual character is greater than a velocity threshold, the spatial change information needing to be optimized; and
the obtaining dynamic resource data of the hair resource in the second game scenario based on the static resource data and the spatial change information comprises:
obtaining the dynamic resource data of the hair resource in the second game scenario based on the static resource data and the optimized spatial change information.

6. The method according to claim 5, wherein the optimizing the spatial change information based on the movement information, to obtain optimized spatial change information comprises:
obtaining a movement threshold corresponding to the movement information;
adding a constraint condition to the virtual character based on difference information between the movement information and the movement threshold; and
optimizing the spatial change information based on the constraint condition, to obtain the optimized spatial change information.

7. The method according to claim 1, wherein the hair resource is a virtual hair attached to the virtual character, the virtual hair is formed by a plurality of strand segments connected in a chain manner, and each strand segment is formed by two vertexes connected through a virtual spring; and
a hair resource set formed by a plurality of hair resources presents a fixed shape.

8. The method according to claim 7, further comprising:
obtaining a plurality of constraint conditions for the hair resource of the virtual character, the plurality of constraint conditions comprising at least a length constraint, and the length constraint being configured for controlling a length of the hair resource to remain unchanged in a movement process of the virtual character;
adjusting a calculation sequence of the plurality of constraint conditions in a process of sequentially calculating the plurality of constraint conditions, to enable an adjusted length constraint to be located at a tail calculation position in a calculation process; and
obtaining a constraint formula of the length constraint, and adding a constraint parameter to the constraint formula, the constraint parameter being configured for correcting a length of the hair resource of the virtual character after the movement.

9. The method according to claim 7, further comprising:
obtaining a local shape constraint of the hair resource set, and updating the local shape constraint by using a first identification coefficient;
performing identification processing on the hair resource set by using an updated local shape constraint, to obtain a first hair set in the hair resource set, a hair spreading probability of the hair resource in the first hair set being greater than a preset threshold; and
performing constraint processing on each hair resource in the first hair set, to obtain a constraint hair set, a hair spreading probability of each hair resource in the constraint hair set being less than or equal to the preset threshold.

10. The method according to claim 7, wherein a vertex of the hair resource is set with an elasticity attribute, and the method further comprises:
obtaining a local shape constraint of the hair resource set, and updating the local shape constraint by using a second identification coefficient;
performing identification processing on the hair resource set by using an updated local shape constraint, to obtain a second hair set in the hair resource set, the second hair set being a root resource set or a tail resource set of the hair resource set;
obtaining an acceleration of a vertex of the hair resource in the second hair set;
determining an attribute value of the elasticity attribute for the vertex based on the acceleration if the acceleration is greater than an acceleration threshold;
obtaining a global movement parameter of the hair resource set, and performing weighted processing on the global movement parameter by using the attribute value, to obtain a weighted processing result; and
determining the weighted processing result as a vertex movement parameter of the vertex of the hair resource in the second hair set, the vertex movement parameter being configured for controlling a movement effect of the vertex.

11. The method according to claim 7, further comprising:
obtaining, in a process of calculating the global movement parameter of the hair resource set through a thread, a hair resource processed by the thread, and performing hair identification processing on the hair resource, to obtain an identification result of the hair resource, the identification result indicating that the hair resource is a guide strand or a follow strand, and the follow strand being obtained by offsetting the guide strand; or the identification result indicating that the vertex corresponding to the hair resource is a root vertex or a non-root vertex of the hair resource, and the root vertex and an attached object of the hair resource remaining relatively fixed; and
interrupting processing of the thread if the identification result indicates that the hair resource is the follow strand or the identification result indicates that the vertex corresponding to the hair resource is the root vertex of the hair resource; or
continuing processing of the thread if the identification result indicates that the hair resource is the guide strand or the identification result indicates that the vertex corresponding to the hair resource is the non-root vertex of the hair resource.

12. The method according to claim 1, further comprising:
obtaining a quantity K of to-be-produced hair resources, K being a positive integer;
dividing the quantity K into m generation groups, k hair resources being generated in parallel in each generation group, m*k≥K, and m and k being positive integers;
obtaining, if m*k>K, m*k−K hair resources from an m^{th} generation group of the m generation groups; and
setting the m*k−K hair resources to a hidden state, the hidden state indicating that the m*k−K hair resources are hidden during rendering.

13. The method according to claim 1, further comprising:
obtaining a parameter group needed for drawing the hair resource, the parameter group comprising a plurality of parameters;
performing association analysis on the plurality of parameters in the parameter group, to obtain an association relationship between the parameters in the parameter group; and
determining a parameter value of each parameter in a virtual world based on a parameter value of each parameter in a real world and the association relationship between the parameters.

14. One or more non-transitory computer readable media storing computer readable instructions which, when executed by a processor, configure a data processing system to perform:
determining that a virtual character changes position within a world space coordinate system when the virtual character moves from a first game scenario to a second game scenario;
obtaining static resource data of a hair resource of the virtual character in the second game scenario, the static resource data being configured for reflecting a static characteristic of the hair resource associated with the virtual character when the virtual character is in a static state in the second game scenario;
obtaining dynamic resource data of the hair resource in the second game scenario based on the static resource data and the position change of the virtual character, the dynamic resource data being configured for reflecting a dynamic characteristic that the hair resource moves with the virtual character; and
performing physical simulation on the hair resource based on the dynamic resource data, the physical simulation being configured for controlling the hair resource to simulate hair movement during a process in which the virtual character moves from the first game scenario to the second game scenario.

15. The computer readable media according to claim 14, wherein one game scenario corresponds to one image frame, and the image frame is configured for describing the game scenario from an image dimension, and the determining comprises:
obtaining a first image frame corresponding to the first game scenario, and calculating first spatial position information of the virtual character in the first image frame in the world space coordinate system;
obtaining a second image frame corresponding to the second game scenario, and calculating second spatial position information of the virtual character in the second image frame in the world space coordinate system; and
calculating the spatial change information of the virtual character based on the first spatial position information and the second spatial position information.

16. The computer readable media according to claim 14, wherein the determining comprises determining displacement information and rotation information, the dynamic resource data of the hair resource in the second game scenario comprises dynamic position information and dynamic direction information, and
wherein the obtaining dynamic resource data of the hair resource in the second game scenario based on the static resource data and the spatial change information comprises:
determining static position information of the hair resource in the second game scenario from the static resource data, and determining the dynamic position information of the hair resource in the second game scenario based on the static position information and the displacement information in the spatial change information; and
determining static direction information of the hair resource in the second game scenario from the static resource data, and determining the dynamic direction information of the hair resource in the second game scenario based on the static direction information and the rotation information in the spatial change information.

17. The computer readable media according to claim 14, wherein the performing physical simulation on the hair resource based on the dynamic resource data comprises:
obtaining one or more constraint conditions to which the virtual character is subjected in the process in which the virtual character moves from the first game scenario to the second game scenario, the constraint condition comprising at least one of the following: a gravity constraint, a length constraint, or a resistance constraint; and
performing physical simulation on a root vertex of the hair resource based on the one or more constraint conditions and the dynamic resource data, the hair resource being a virtual hair formed by a plurality of chained vertexes, and the root vertex being two adjacent vertexes attached to an attached object in the hair resource.

18. The computer readable media according to claim 14, further comprising:
obtaining movement information of the virtual character, the movement information comprising at least one of the following: a displacement distance, a displacement direction, and velocity information;
optimizing the spatial change information based on the movement information, to obtain optimized spatial change information if it is detected that the spatial change information needs to be optimized based on the movement information, if the displacement distance is greater than a displacement distance threshold, the spatial change information needing to be optimized, or if the displacement distance is less than or equal to a displacement distance threshold, the displacement direction indicating that a movement direction of the virtual character in the first game scenario is different from a movement direction of the virtual character in the second game scenario, and the velocity information indicating that a velocity of the virtual character is greater than a velocity threshold, the spatial change information needing to be optimized; and
the obtaining dynamic resource data of the hair resource in the second game scenario based on the static resource data and the spatial change information comprises:
obtaining the dynamic resource data of the hair resource in the second game scenario based on the static resource data and the optimized spatial change information.

19. The computer readable media according to claim 18, wherein the optimizing the spatial change information based on the movement information, to obtain optimized spatial change information comprises:
obtaining a movement threshold corresponding to the movement information;
adding a constraint condition to the virtual character based on difference information between the movement information and the movement threshold; and
optimizing the spatial change information based on the constraint condition, to obtain the optimized spatial change information.

20. A system, comprising:
a processor; and
memory storing computer readable instructions which, when executed by the processor, configure the system to perform:
determining that a virtual character changes position within a world space coordinate system when the virtual character moves from a first game scenario to a second game scenario;
obtaining static resource data of a hair resource of the virtual character in the second game scenario, the static resource data being configured for reflecting a static characteristic of the hair resource associated with the virtual character when the virtual character is in a static state in the second game scenario;
obtaining dynamic resource data of the hair resource in the second game scenario based on the static resource data and the position change of the virtual character, the dynamic resource data being configured for reflecting a dynamic characteristic that the hair resource moves with the virtual character; and
performing physical simulation on the hair resource based on the dynamic resource data, the physical simulation being configured for controlling the hair resource to simulate hair movement during a process in which the virtual character moves from the first game scenario to the second game scenario.
